(19) United States
(12) Patent Application Publication
(10) Pub. No.: US 2006/0029697 A1
(43) Pub. Date: Feb. 9, 2006

(54) Food wraps and bags with cling properties and method of manufacture

(76) Inventors: Bruce Robbins, Richmond, VA (US); Monica Stautner Nichols, Richmond, VA (US); Giles Douglas Powell JR., Richmond, VA (US)

Correspondence Address: ECKERT SEAMANS CHERIN & MELLOTT, LLC;ALCOA TECHNICAL CENTER, 100 TECHNICAL DRIVE, ALCOA CENTER, PA, 15069-0001, US

(21) Appl. No.: 11/197,086

(22) Filed: Aug. 4, 2005

Related U.S. Application Data
(60) Provisional application No. 60/599,470, filed on Aug. 5, 2004.

(51) Int. Cl. A21D 13/00

(52) U.S. Cl. 426/138

(57) ABSTRACT

This invention discloses a bag or wrap having hair like protrusions extending substantially perpendicular to a surface of the bag or wrap thereby enabling the bag or wrap to attach or cling to other surfaces. This invention also discloses a method of making a bag or wrap having the hair like protrusions.

### CROSS REFERENCE TO RELATED APPLICATIONS

This application claims the benefit of U.S. Provisional Application Ser. No. 60/599,470, filed on Aug. 5, 2004, the disclosure of which is fully incorporated by reference herein.

### FIELD OF THE INVENTION

The present invention relates to wraps and bags. Specifically, this invention relates to wraps and bags having protrusions that exhibit adhesive like qualities extending from a surface of the wrap or bag.

### BACKGROUND OF THE INVENTION

In today's food industry, plastic films as well as metal foils are extensively used to wrap and package food products. The plastic film and the metal foil can either directly wrap the food product or they can be used as a top or a cover to the bowl or plate in which the food product is contained. Unless an adhesive is applied on one or more sides of the plastic film or metal foil, it is usually difficult for the film or foil to adhere (i.e. attach or cling) to the different types of surfaces that might be used in the bowls or plates that are used to contain the food product. For instance, Reynolds Plastic Wrap is made from a polyvinyl chloride based plastic. Even though Reynolds Plastic Wrap easily adheres to a surface such as glass, it does not adhere very well to surfaces made from wood or some plastics. As stated above, in order to increase the ability of the plastic film or foil to adhere to a particular surface, such as wood or plastic, some products are comprised of a high density polyethylene film with an adhesive on one side. One drawback of using such an adhesive, however, is that the adhesive can be transferred to the actual food product or it can be transferred to the bowl or plate in which the food product is contained.

Metal foils, such as those made from aluminum, generally do not have any adherence (i.e. cling) properties. In other words, metal foils that are currently used in the industry do not adhere to most surfaces. Accordingly, when a metal foil is used either as a food wrap or as a cover to a bowl or plate the metal foil is typically crimped around the food product or the food container in order to secure the metal foil to the food product or to the food container.

Plastic storage bags typically used in the food industry have a tongue and groove recloseable zipper with or without a slider assist. Some cooking and storage bags, however, which rely on a twist tie or some other closure mechanism that is a separate and distinct piece from the cooking or storage bag in order to seal or close the bag. One drawback to these closure mechanisms is that they can fail periodically. For instance, the recloseable zipper might not be closed sufficiently to prevent the food contents from escaping between the two flanges that typically comprises a recloseable zipper. If a twist tie is used on the bag, then the twist tie could accidentally be removed thereby allowing the contents of the cooking or storage bag to escape from the bag.

Trash bags and trash liners are similar to metal foil in that they generally do not adhere to most surfaces. In other words, a typical trash bag or trash liner does not adhere to the waste container in which it is placed. Accordingly, a typical trash bag or trash liner is susceptible to unwanted movement when an item is placed in the waste container. For example, if a heavy item is dropped into the waster container there is a possibility that the trash bag or liner would cave in (i.e. collapse) on itself.

Therefore, there exists a need for a bag or wrap having the ability to adhere to a variety of surfaces without having to rely on traditional adhesives to provide the adhesive properties.

### SUMMARY OF THE INVENTION

This invention is a response to his need by disclosing a food wrap having hair like protrusions extending substantially perpendicular to a surface of the food wrap thereby enabling the food wrap to attach or cling to other surfaces.

This invention also discloses a bag having hair like protrusions extending substantially perpendicular to a surface of the bag thereby enabling the bag to attach or cling to other surfaces.

This invention also discloses a trash bag having hair like protrusions extending substantially perpendicular to a surface of the trash bag thereby enabling the trash bag to attach or cling to other surfaces.

This invention also discloses a method of preparing a wrap or bag having hair like protrusion extending substantially perpendicular to a surface of the wrap or bag thereby enabling the wrap or bag to attach or cling to other surfaces. The method includes using electron beam lithography or laser ablation to prepare a positive surface relief on a master substrate that is suitable for electroforming, electroforming a layer of metal onto a surface of the master substrate to produce a first metal layer having a negative image of the master substrate, affixing the first metal layer onto a first roll or belt, and advancing the wrap or bag through a nip that is located between the first roll or belt and a second roll or belt.

This invention also discloses a method of preparing a wrap or bag having hair like protrusion extending substantially perpendicular to a surface of the wrap or bag thereby enabling the wrap or bag to attach or cling to other surfaces. The method includes using electron beam lithography or laser ablation to prepare a negative surface relief on a master substrate that is suitable for electroforming, electroforming a layer of metal onto a surface of the master substrate to produce a first metal layer having a positive image of the master substrate, removing the first metal layer from the master substrate and electroforming a layer of metal onto a surface of the first metal layer to produce a second metal layer having a negative image of the first metal layer, affixing the second metal layer onto a first roll or belt, and advancing the wrap or bag through a nip that is located between the first roll or belt and a second roll or belt.

### BRIEF DESCRIPTION OF THE DRAWINGS

FIG. 1 is a cross section of a food wrap having the hair like protrusions that are disclosed in this invention.

FIG. 2 is a cross section of a food wrap with an embossable layer having the hair like protrusions that are described in this invention.

FIG. 3 depicts a typical recloseable storage or cooking bag.

FIG. 4 depicts a typical trash bag having two bands of the hair like protrusions.

FIG. 5 depicts a trash bag located in a trash container.

### DETAILED DESCRIPTION OF PREFERRED EMBODIMENTS

The accompanying figure and the description that follows set forth this invention in its preferred embodiments. However, it is contemplated that persons generally familiar with bags and wraps will be able to apply the novel characteristics of the structures and methods illustrated and described herein in other contexts by modification of certain details. Accordingly, the figures and description are not to be taken as restrictive on the scope of this invention, but are to be understood as broad and general teachings. When referring to any numerical range of values, such ranges are understood to include each and every number and/or fraction between the stated range minimum and maximum. Finally, for purposes of the description hereinafter, the terms “upper”, “lower”, “right”, “left”, “vertical”, “horizontal”, “top”, “bottom”, and derivatives thereof shall relate to the invention, as it is oriented in the drawing figures.

This invention discloses using a surface topography similar to what is observed on the feet of the gecko family, which can be applied to a film, wrap, or bag in order to impart adhesive like qualities to the surface of the film, wrap, or bag. This invention also discloses a method of manufacturing such a surface topography on the film, wrap, or bag.

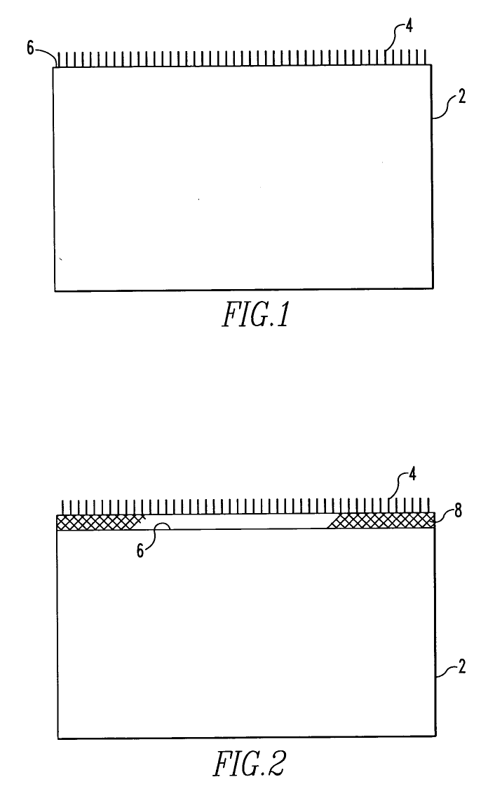

FIG. 1 shows a cross section of a food wrap 2 with a plurality of hair like protrusions 4 extending substantially vertically (i.e. perpendicularly) from the surface 6 of the food wrap 2. The diameter of the protrusions or pillars 4 could range from about 0.2 μm to about 0.5 μm. The height of the protrusions 4 could range from about 0.5 μm to about 5 μm. The shape of the protrusions 4 could be cylindrical, conical, rectangular, pentagonal, hexagonal, or octagonal. If conical, the top of the cone need not come to a point, but could be a flat area in the range of the preferred diameter. The density (i.e. the total number of protrusions per square μm) of protrusions 4 determines the degree of adhesion of the food wrap 2 to other surfaces. In other words, as the number of protrusions 4 increase so does the food wrap's ability to adhere to other surfaces such as glass, wood, metal, and plastic. For instance, the density of the protrusions could range from about 0.02 to 4 per square μm. The food wrap 2 could be manufactured from a variety of materials including but not limited to aluminum foil, plastic film, paper, waxed paper, plastic coated paper, or laminates of any paper, plastic or foil combination. If the material used to manufacture the food wrap 2 is a plastic film or a plastic coated paper, then the plastic can be manufactured from polyethylene, polypropylene, polystyrene, polyvinyl chloride, ethylene copolymers, polyester, styrene butadiene copolymer, or any material suitable for plastic films.

In another embodiment, the food wrap 2 has an embossable layer 8. As depicted in FIG. 2, the embossable layer 8 is positioned over the surface 6 of the food wrap 2. The embossable layer 8 is made from a material that allows a hologram to be produced on the surface of the food wrap 2. For instance, embossable layers currently known and used in the art to produce holograms on metal foil substrates may be utilized with the disclosed invention. In this embodiment, the protrusions 4 extend substantially vertically from the embossable layer 8.

In one embodiment, the thickness of the film or foil used in the food wrap 2 would range from about 0.000508 cm (0.0002 in) to about 0.00508 cm (0.002 in). It is noted, however, that the thickness of the film or foil used in the food wrap 2 could also be thicker or thinner. For instance, the thickness of the film or foil used in the food wrap 2 could range from about 0.000508 cm (0.0002 in) to about 0.0254 cm (0.010 in).

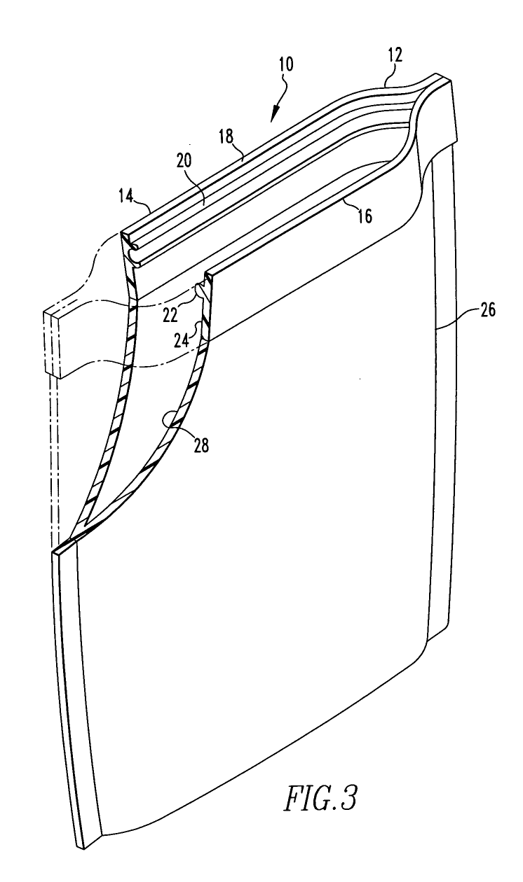

In another embodiment, the protrusions 4 can also be applied to the recloseable storage or cooking bag to supplement the closure mechanism in order to increase the bag's ability to remain sealed. FIG. 3 depicts a typical recloseable plastic storage bag 10. As can be seen from FIG. 3, the recloseable plastic storage bag 10 includes a recloseable zipper 12 (i.e. a closure mechanism) that extends along the length of the recloseable bag 10. The recloseable zipper 12 is comprised of a first skirt or flange 14 and a second skirt or flange 16 that are often extruded from a resin. Extending from the interior surface 18 of the first skirt 14 is a female profile 20 that is adapted to receive the male profile 22 that extends from the interior surface 24 of the second skirt 16. Attached to the each of the skirts 14, 16 is a polymeric panel or film 26. Each panel 26 is attached to its corresponding skirts 14, 16 by a sealant that has a lower melting point than either of the skirts 14, 16, which ensures that the skirts 14, 16 do not melt when the panels 26 are attached. The polymeric panel 26 can be attached to each of the skirts 14, 16 by a sealant that is applied onto the exterior surface of each skirt 14, 16. Alternatively, the polymeric panel 26 can also be attached to each of the skirts 14, 16 by a sealant that is applied onto the interior surface of each skirt.

In one embodiment, the protrusions 4 are located on the interior surface 28 of each polymeric panel 26 above or below the recloseable zipper (i.e. closure mechanism) 12. In this particular embodiment, the protrusions 4 would supplement the recloseable zipper 12 in maintaining a sealed or closed bag 10 when the male and female profiles 20, 22 of the first and second skirts 14, 16 are interlocked since the protrusions 4 would adhere to one another when they come into contact. In another embedment, the protrusions 4 would once again be located either above or below the recloseable zipper 12. Unlike the previous embodiment, however, the protrusions 4 in this embodiment would be located on the interior surface 28 of only one polymeric panel 26.

In yet another embodiment, the recloseable plastic storage bag 10 does not have a recloseable zipper 12 (closure mechanism). Rather, the recloseable plastic storage bag 10 is sealed by protrusions 4 that extend from the interior surface 28 of each polymeric panel or film 26. In other words, in this particular embodiment the protrusions 4 replace the recloseable zipper 12 as the mechanism to close the recloseable plastic storage bag 10. Accordingly, the protrusions 4 would extend along the length of the recloseable bag 10 while extending substantially perpendicularly from the interior surface 28 of each polymeric panel. In another embodiment, the protrusions 4 would extend from the interior surface 28 of only one polymeric panel 26.

If the material used to manufacture the recloseable storage or cooking bag is a plastic film or a plastic coated paper, then the plastic can be manufactured from polyethylene, polypropylene, polystyrene, polyvinyl chloride, ethylene copolymers, polyester, styrene butadiene copolymer, or any material suitable for plastic films.

In one embodiment, the thickness of the film or used in the recloseable storage or cooking bag would range from about 0.000508 cm (0.0002 in) to about 0.00508 cm (0.002 in). It is noted, however, that the thickness of the film or foil used in the storage or cooking bag could also be thicker or thinner. For instance, the thickness of the film or foil used in the recloseable storage or cooking bag could range from about 0.000508 cm (0.0002 in) to about 0.0254 cm (0.010 in).

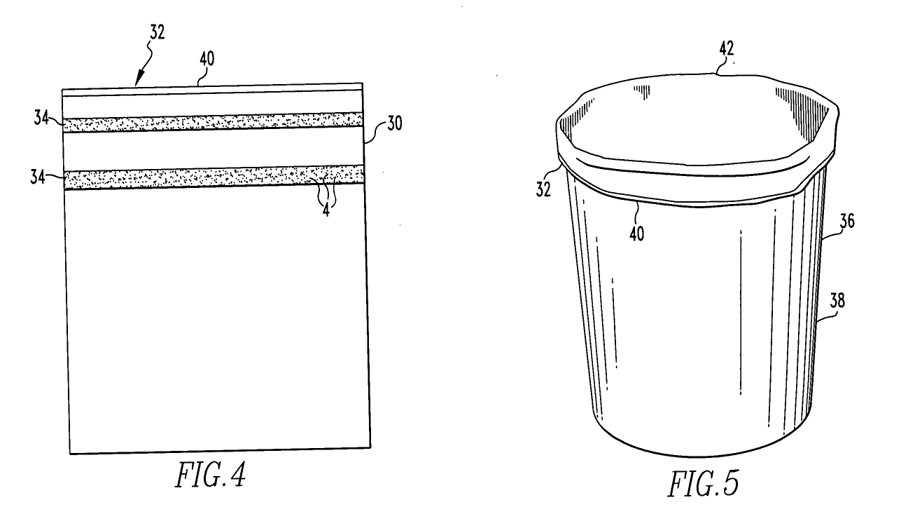

As can be seen from FIG. 4, the protrusions 4 that are disclosed in this invention could also be applied to the exterior surface of a trash bag or trashcan liner 32 in one or more locations. In FIG. 4, the protrusions 4 are located in two distinct bands 34 that extend along the length of the trash bag 32. As depicted in FIG. 5, when the trash bag or trashcan 32 liner is placed within a trash container (i.e. trash can) 36 the exterior surface (30 in FIG. 4) of the trash bag or liner 32 is adjacent to and is in partial or compete contact with the interior surface of the trash can 36. In FIG. 5, the exterior surface of the trash bag 32 is not only in contact with the interior surface of the trash can 36 but it is also in contact with the trash can's 36 exterior surface 38 because in this figure the first edge 40 of the trash bag 32 is folded over the trash can's first edge 42. Since the protrusions 4 extend from the exterior surface of the trash bag 32, the trash bag 32 would adhere or cling to the interior as well as the exterior surfaces of the trash can due to the adhesive properties of the protrusions 4 thereby securing the trash bag 32 to the trash can 36.

If the material used to manufacture the trash bag is a plastic film, then the plastic can be manufactured from polyethylene, polypropylene, polystyrene, polyvinyl chloride, ethylene copolymers, polyester, styrene butadiene copolymer, or any material suitable for plastic films.

In one embodiment, the thickness of the film used in the trash bag or trashcan liner 32 would range from about 0.000508 cm (0.0002 in) to about 0.00508 cm (0.002 in). It is noted, however, that the thickness of the film used in the trash bag or trashcan liner 32 could also be thicker or thinner. For instance, the thickness of the film or foil used in the recloseable storage or cooking bag could range from about 0.000508 cm (0.0002 in) to about 0.0254 cm (0.010 in).

By using embossing techniques similar to the techniques that are currently used to produce holograms in substrates, the surface topography of a plastic or metal substrate may be altered to contain the hair like protrusions that are disclosed in this invention. The major difference between the technique that is used to produce holograms and the technique that is used to create the protrusions lies in the preparation of the master shim. In the method that is disclosed in this invention, a positive or negative image of the desired shape as well as the density of the hair like protrusions are generated into a master substrate, which is a substrate that is suitable for electroforming, using electron beam lithography or laser ablation. In one embodiment, the master substrate that is used is manufactured from silicon, tungsten carbide, or silicon nitride. The dimensions of the original master substrate could be several square centimeters and can be replicated by techniques known in the art of holography to obtain a larger square area thereby allowing the user to produce an area having the hair like protrusions in the dimensions that are required for a particular product. In other words, Techniques common to the reproduction of holographic images can be used to replicate the original pattern to provide a larger surface area of the desired pattern on the original positive or negative master substrate. For clarity, the surface of a negative master substrate is comprised of “pillars” that are in the shape and the density of the hair like protrusions that are to be imparted onto the surface of the panel or film. In contrast, the surface of a positive master substrate is comprised of holes that are in the shape and the density of the hair like protrusions that are to be transferred onto the surface of the panel or film. In other words, these holes could be cylindrical, conical, rectangular, pentagonal, hexagonal, or octagonal in shape.

A first metal layer is then electroformed onto the positive or negative master substrate using techniques that are well known in the art. In one embodiment, the metal that is used in the first metal layer is nickel. If the original master substrate is a negative image of the hair like protrusions, then the first metal layer that is applied over the negative master substrate would be a positive image of the hair like protrusions. The first metal layer having the positive image of the hair like protrusions is then peeled away or removed from the negative master substrate and a second metal layer is electroformed onto the first metal layer. In one embodiment, the metal that is used in the second metal layer is nickel. Accordingly, the second metal layer is a negative image of the first metal layer. In other words, the second metal layer is a reproduction of the original negative master substrate. This second metal layer is then affixed to an embossing roll or belt as the master shim in order to impart or transfer the hair like protrusions onto the surface of the film or panel by passing the film or panel through an embossing nip that is located between the embossing roll and a second roll.

If the original master substrate was a positive image of the hair like protrusions, then the first metal layer that is applied over the original positive master would be a negative image of the hair like protrusions. In one embodiment, the metal that is used in the first metal layer is nickel. This first metal layer, which is a negative image of the original positive master, would then be affixed to an embossing roll or belt as the master shim so that the hair like protrusions can be transferred onto the film or panel by passing the film or panel through an embossing nip that is located between the embossing roll and a second roll.

It is noted that each electroformed metal layer is considered a generation. Accordingly, subsequent generations may be electroformed from previous generations. The number of generations created prior the final generation, which is used as the shim or tooling to impart the hair like protrusions on the film or panel, is not meant to be limiting so long as the final generation is a negative image of the hair like protrusions. In other words, the metal layer that is used as the final generation will have hair like protrusions (i.e. pillars) extending substantially perpendicularly from a surface of the metal layer thereby allowing this metal layer to transfer a positive image of the hair like protrusions onto the plastic or metal substrates.

Having described the presently preferred embodiments, it is to be understood that the invention may be otherwise embodied within the scope of the appended claims.

What is claimed is:

1. A food wrap comprising hair like protrusions extending substantially perpendicular to a surface of said food wrap, said hair like protrusions enable said food wrap to attach or cling to other surfaces.

2. A food wrap according to claim 1 wherein said hair like protrusions have a diameter ranging from about 0.2 to about 0.5 μm.

3. A food wrap according to claim 1 wherein said hair like protrusions have a height ranging from about 0.5 to about 5 μm.

4. A food wrap according to claim 1 wherein said wrap is made from an aluminum foil.

5. A food wrap according to claim 1 wherein said wrap is made from a plastic film.

6. A food wrap according to claim 5 wherein said plastic film is manufactured from polyvinyl chloride, polyethylene, an ethylene copolymer, polyester, polystyrene, or styrene butadiene copolymer.

7. A food wrap according to claim 1 wherein said food wrap is made from a lamination of any combination of metal foil, plastic film, or paper.

8. A food wrap according to claim 1 wherein an embossable layer is located over said surface.

9. A food wrap according to claim 8 wherein said hair like protrusions is embossed into said embossable layer.

10. A food wrap according to claim 1 wherein said hair like protrusions are arranged in a pattern and said pattern is formed such that said hair like protrusions are in the hollows of an embossed or otherwise formed pattern, such that the adhering properties are engaged when the wrap is pressed, exposing the protrusions.

11. A bag comprising hair like protrusions extending substantially perpendicular to a surface of said bag, said hair like protrusions enable said oven bag to attach or cling to other surfaces.

12. A bag according to claim 11 wherein said bag is a storage bag, a cooking bag, or a trash bag.

13. A bag according to claim 11 further comprising a closure mechanism, said closure mechanism having said hair like protrusions extending substantially perpendicularly to an interior surface of said closure mechanism.

14. A bag according to claim 11 wherein said bag is manufactured from a plastic.

15. A bag according to claim 14 wherein said plastic is polyvinyl chloride, polyethylene, an ethylene copolymer, polyester, polystyrene, nylon, or styrene butadiene copolymer.

16. A method of preparing a wrap or a bag having hair like protrusions extending substantially perpendicular to a surface of said wrap or bag, said hair like protrusions enable said wrap or bag to attach or cling to other surfaces comprising:
using electron beam lithography or laser ablation to prepare a positive surface relief on a master substrate that is suitable for electroforming;
electroforming a layer of metal onto a surface of said master substrate to produce a first metal layer having a negative image of said master substrate; and
affixing said first metal layer onto a first roll or belt;
advancing said wrap or bag through a nip that is located between said first roll or belt and a second roll or belt.

17. A method of preparing a wrap or a bag having hair like protrusions according to claim 16 wherein using electron beam lithography or laser ablation to prepare a positive surface relief on a master substrate that is suitable for electroforming, said master substrate being manufactured from silicon, tungsten carbide, or silicon nitride.

18. A method of preparing a wrap or a bag having hair like protrusions according to claim 16 wherein electroforming a layer of metal onto said master substrate to produce a first metal layer having a negative image of said master substrate, said metal being nickel.

19. A method of preparing a wrap or a bag having hair like protrusions extending substantially perpendicular to a surface of said wrap or bag, said hair like protrusions enable said wrap or bag to attach or cling to other surfaces comprising:
using electron beam lithography or laser ablation to prepare a negative surface relief on a master substrate that is suitable for electroforming;
electroforming a layer of metal onto a surface of said master substrate to produce a first metal layer having a positive image of said master substrate;
removing said first metal layer from said master substrate and electroforming a layer of metal onto a surface of said first metal layer to produce a second metal layer having a negative image of said first metal layer;
affixing said second metal layer onto a first roll or belt;
advancing said wrap or bag through a nip that is located between said first roll or belt and a second roll or belt.

20. A method of preparing a wrap or a bag having hair like protrusions according to claim 19 wherein using electron beam lithography or laser ablation to prepare a negative surface relief on a master substrate that is suitable for electroforming, said master substrate being manufactured from silicon, tungsten carbide, or silicon nitride.

21. A method of preparing a wrap or a bag having hair like protrusions according to claim 19 wherein:
electroforming a layer of metal onto said master substrate to produce a first metal layer having a positive image of said master substrate, said metal being nickel; and
removing said first metal layer from said master substrate and electroforming a layer of metal onto a surface of said first metal layer to produce a second metal layer having a negative image of said first metal layer, said metal being nickel.
